(19) United States
(12) Patent Application Publication
(10) Pub. No.: US 2010/0171297 A1
(43) Pub. Date: Jul. 8, 2010

(54) CHASSIS

(75) Inventor: Andrew North, Oxford (GB)

Correspondence Address: SCULLY SCOTT MURPHY & PRESSER, PC, 400 GARDEN CITY PLAZA, SUITE 300, GARDEN CITY, NY, 11530, US

(73) Assignee: BAE SYSTEMS PLC, London (GB)

(21) Appl. No.: 12/299,869

(22) PCT Filed: Sep. 3, 2008
(86) PCT No.: PCT/GB2008/050771

§ 371 Date: Nov. 6, 2008

(30) Foreign Application Priority Data
Sep. 11, 2007 (EP) 07253612.1
Sep. 11, 2007 (GB) 0717699.3

(51) Int. Cl. B62D 21/02; B62D 21/00; B62D 21/15

(52) U.S. Cl. 280/781

(57) ABSTRACT

A chassis for a high mobility vehicle is disclosed. The chassis comprises a tubular transmission member extending from a foremost axle to a rearmost axle, thereby defining a transmission axis; a first structural member arranged generally parallel to the transmission axis, and attached to the transmission member; and a deflection means arranged such that, if the vehicle, in use, encounters an obstacle having a height greater than the clearance of the deflection means above the ground, the deflection means are operable in combination with the first structural member and the transmission member to cause the vehicle to overcome the object.

The following invention relates to a chassis for a High Mobility Vehicle (HMV), and in particular to such a chassis comprising a tubular transmission member and reinforced to withstand collisions on the front undercarriage.

It is desirable that a multi-axle drive HMV be able to drive on a variety of terrains. In use, the HMV may encounter obstacles such as boulders that if driven over may strike prominent members of the undercarriage. Further, the HMV may encounter abrupt and continued changes in the inclination of the terrain. Depending on the inclination of such terrain and the arrangement of the HMV, the terrain may strike prominent members on the front of the HMV such as the bumper.

It is known to have a HMV comprising a Tubular Transmission Member. This Tubular Transmission Member (TTM) acts as the major load bearing structure in the vehicle and also locates features of the drive train. It runs in a straight line along the undercarriage from the foremost axle to the rearmost axle.

Where a HMV comprises a TTM it is known to improve tolerance to abrupt changes in terrain incline by providing an inclined load bearing member or surface extending from the TTM and reaching up from the front axle (i.e. the foremost part of the TTM) towards a HMV bumper (i.e. the foremost part of the HMV). The HMV bumper is positioned forward of and above the front axle. This gives a form of undercarriage that, within limits, accommodates an abrupt change in terrain incline.

Further, this inclined member or surface is rigid so that when struck by a static obstacle as the HMV drives over it, the reaction to the impact tends to raise the HMV off the ground at its front wheels. This helps the HMV to overcome obstacles when the height of the obstacle exceeds the clearance of the front axle.

However, in known HMVs this is an imperfect procedure for overcoming obstacles because the reaction to the impact may give rise to high bending stresses; the inclined load bearing member or surface is offset from the axis of the TTM and so creates a considerable moment arm about the connection between the TTM and the inclined surface or member. The connection between the TTM and the inclined surface or member is generally a casing (for a differential gear) fabricated from a light material such as cast aluminium. Such casings are not typically intended to withstand such bending stresses and may fail under them.

It is therefore an object of the present invention to provide a structure for a chassis which is reinforced to mitigate the stress generated upon impact with an obstacle. It is a further object of the present invention to overcome, or at least partially mitigate, some of the above-mentioned problems.

Accordingly, in accordance with one aspect of the present invention, there is provided a chassis for a high mobility vehicle, the chassis comprising:

a tubular transmission member extending from a foremost axle to a rearmost axle, thereby defining a transmission axis;

a first structural member arranged generally parallel to the transmission axis, and attached to the transmission member; and

a deflection means arranged such that, if the vehicle, in use, encounters an obstacle having a height greater than the clearance of the deflection means above the ground, the deflection means are operable in combination with the first structural member and the transmission member to cause the vehicle to overcome the object.

Such a chassis advantageously reduces the bending moment experienced when prominent members of the undercarriage are struck because the provision of the extra structural members provides an alternative force path which dissipates the stress.

There may be a second structural member arranged generally parallel to the transmission axis, and attached to the transmission member; and the deflection means may be operable in combination with the first and second structural members, and the transmission member, to cause the vehicle to overcome the object.

The first and second structural members may define a plane, which, when the vehicle is travelling over the ground, is above the transmission member

Optionally, each of the first and second structural members have a C-shaped cross section and the first and second structural members are arranged in relation to each other such that the open part of the members face away from each other.

This gives rise to the advantage that components relating to other aspects of the vehicle, such as air suspension modules, can easily be fixed onto the structural members by arranging mounts within the section. This reduces build time and makes repair simpler.

Preferably, the deflection means comprise a plurality of prominent undercarriage surfaces inclined to the tubular transmission member, the prominent undercarriage surfaces being located such that, when the vehicle is in motion across the ground, each prominent undercarriage surface is at a difference height above the ground.

By providing a plurality of prominent undercarriage surfaces, the reaction of the vehicle to obstacles of different heights can be improved.

The deflection means may comprise a hammer head section comprising a neck and a wedge, the neck attaching to the foremost end of the tubular transmission member, the wedge providing a first prominent undercarriage surface.

Advantageously the first prominent surface shields the foremost part of the TTM and so the hammer head section provides protection to the transmission from sudden impacts. Damage to the hammer head section is acceptable but damage to the transmission would not be because this could inhibit the vehicle's ability to drive.

Preferably, the inclined surface of the hammer head does not extend upwards further than to the structural members.

This beneficially reduces the moment arm of the hammer head since it is restricted from extending to large distances which could lead to the inducement of great bending stress.

Optionally, the hammer head is attached to the first structural member at a first side of the wedge and is attached to the second structural member at a second side of the wedge.

This further enhances the structural rigidity of the chassis and also guarantees that stresses arising from foreign objects collisions with the hammer head are bourne by the transmission tube, and the structural members. This reduces the maximum stress experienced by the chassis.

There may be a plate member to which the foremost portions of the structural members are attached.

This beneficially acts to both reinforce the connections between the two structural elements and also forms a foundation for a vehicle cab. By fulfilling both of these roles with one component, the chassis minimises weight and reduces build time.

Optionally, the plate member comprises a trough section which is aligned in a space between the structural members and the tubular transmission member axis, wherein a second prominent undercarriage surface is provided by an outer surface of the trough section.

This beneficial feature of the chassis serves two purposes. Firstly, it forms an internal space which can be used as a footwell in the vehicle cab. Secondly, it provides a further surface for effecting the obstacle overcoming function of the vehicle.

Preferably, the deflection means comprises a bumper, the bumper providing a third prominent undercarriage surface attitudinally inclined to the transmission member axis. The inclined bumper surface preferably extends downwards no further than to the transmission member. This advantageously enables the vehicle to overcome obstacles having a clearance approximately equal to the third prominent undercarriage surface. With this feature, the chassis can react off of obstacles that strike the inclined surface. By restricting the size of the bumper surface so that it does not extend further than to the transmission member, bending stressed are minimised and forces are more likely to be spread between the TTM and the structural members.

An embodiment of the present invention will now be described, by way of example only, with reference to the following figures, of which:

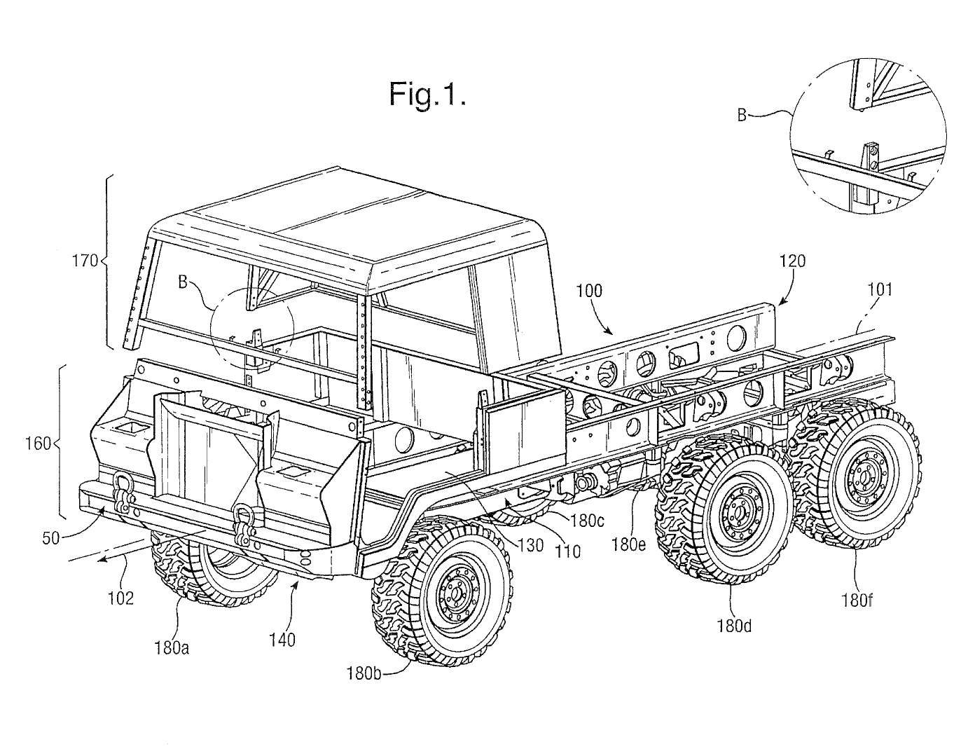

FIG. 1 shows a geometric view of the arrangement of a chassis, wheels, and exploded cab in a three-axle drive HMV.

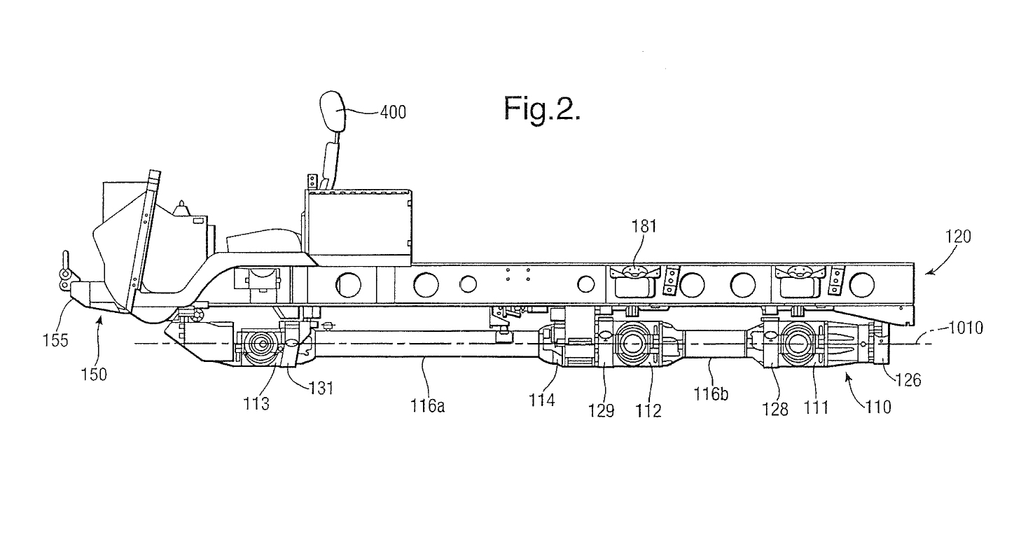

FIG. 2 shows a side view of a chassis of a three-axle drive HMV

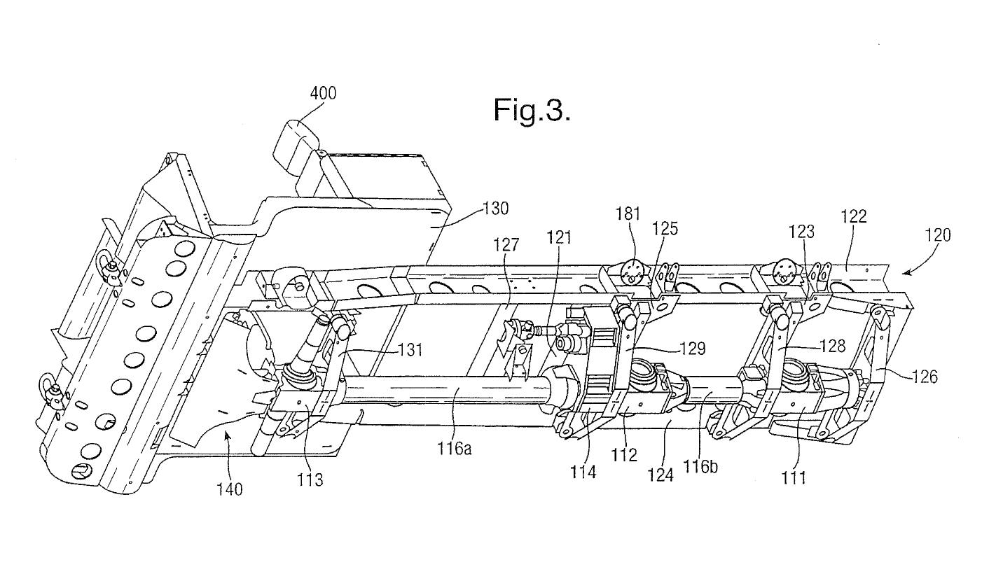

FIG. 3 shows a geometric view from below of the three-axle drive HMV chassis.

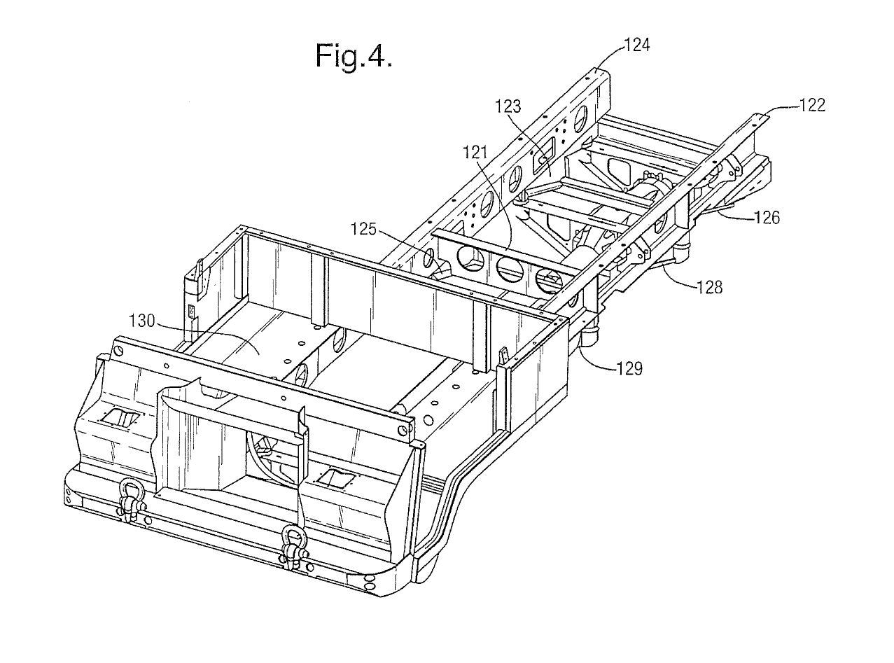

FIG. 4 shows a geometric view from above of the three-axle drive HMV chassis.

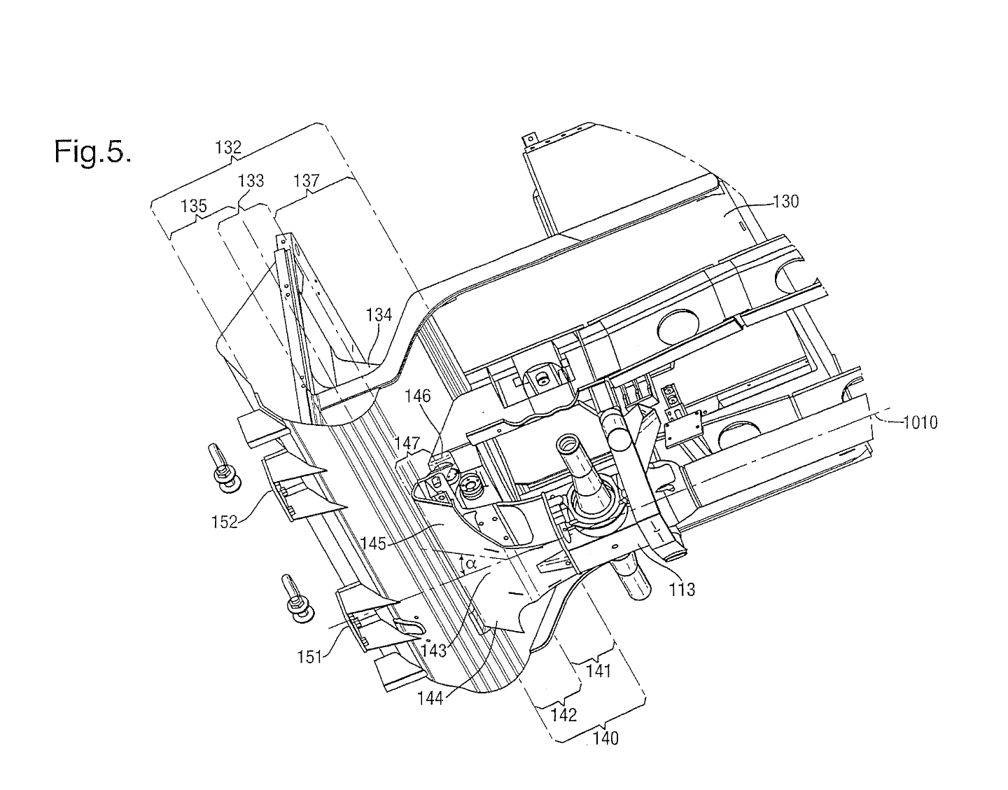

FIG. 5 shows a close up geometric view of the foremost undercarriage of the three-axle drive HMV chassis, wheels have been omitted for ease of viewing.

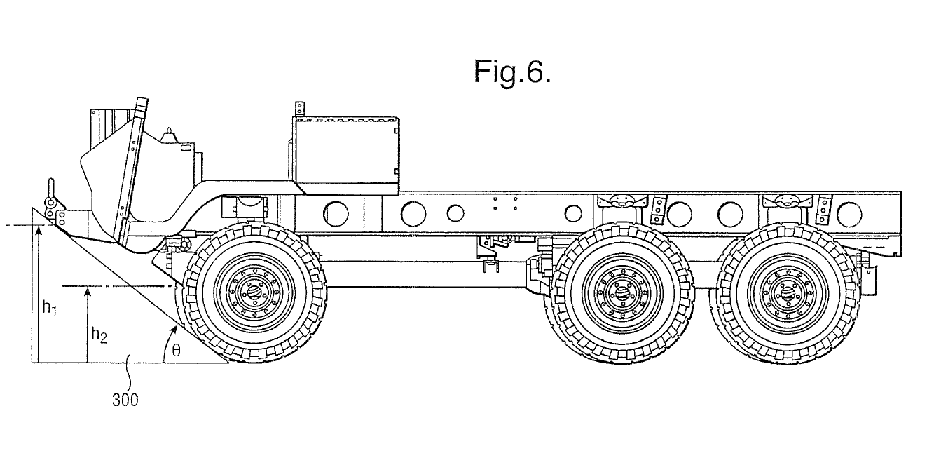

FIG. 6 shows a side view of the three-axle drive HMV (as represented by a wheeled chassis) as it approaches a surface having incline θ.

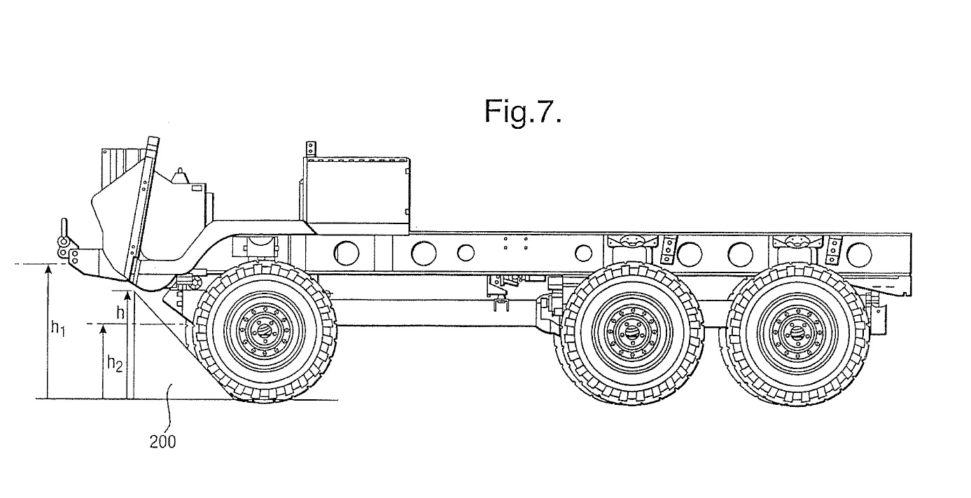

FIG. 7 shows a side view of the three-axle drive HMV (as represented by a wheeled chassis) as it approaches an obstacle with height h.

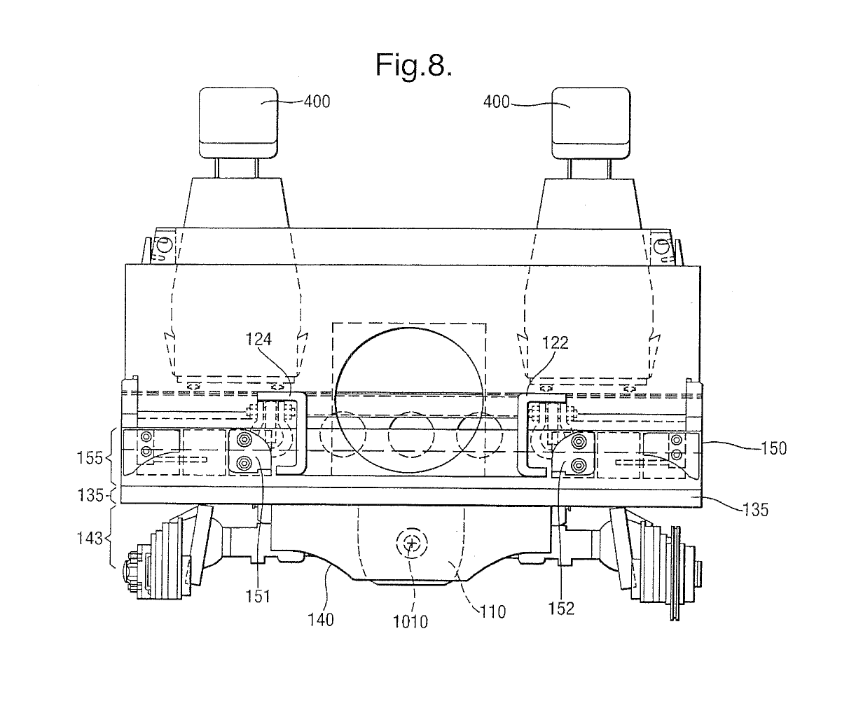

FIG. 8 shows a front on view of the chassis with dotted lines representing hidden components. Thicker outlines highlight certain rigid components. Shading indicates the location of prominent undercarriage surfaces.

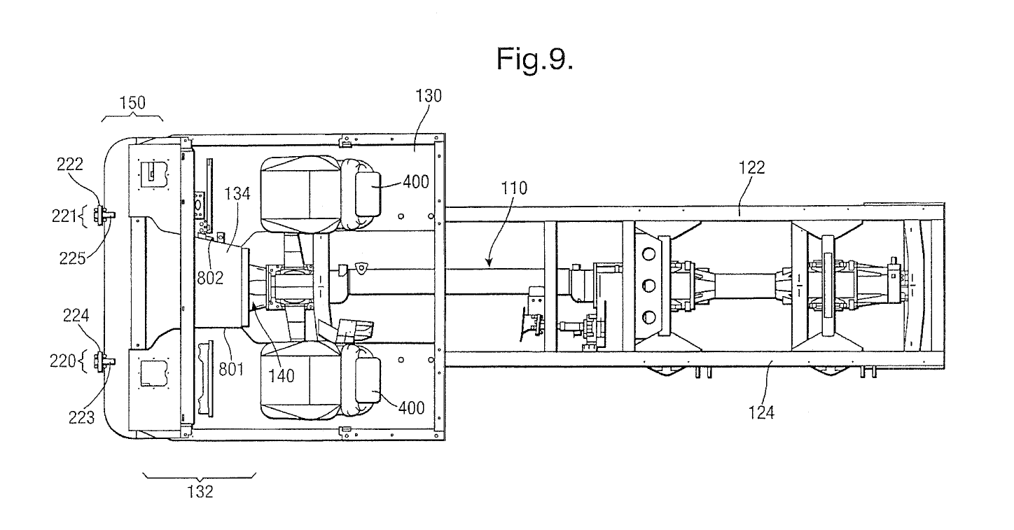

FIG. 9 shows the chassis viewed from above and in a direction normal to the longitudinal/lateral plane. Referring primarily to FIG. 1, in the three-axle drive HMV of the present embodiment, a chassis (generally indicated at 100) comprises a tubular transmission member 110, a ladder structure 120, a rigid plate member 130, a hammer head plate 140 and a bumper 150. Rigid plate member 130 is part of a lower cab structure 160 which has an upper interface surface for engaging the lower interface surface of an upper cab 170. In FIG. 1, six wheels 180a-f are arranged in pairs on axles making up the transmission. The foremost wheels, 180a and 180b are fixed on the foremost axle. The rearmost wheels 180e and 180f are fixed on the rearmost axle. The vehicle is three-axle drive, alternatively referred to as six wheel drive.

It can be appreciated that the vehicle incorporating the chassis 100 defines a longitudinal axis 101. As the vehicle moves forwards (or backwards) in a straight line 102, it travels along this longitudinal axis 101.

Referring primarily to FIGS. 2 and 3 the arrangement of the tubular transmission member 110 is further explained. Tubular transmission member 110 acts to make the chassis rigid. Tubular transmission member 110 comprises rigid tubing 116a,b which not only shields dynamic components of the transmission from dirt but also acts as a load bearing member as the chassis experiences operational loads.

A foremost axle differential gear casing 113 is attached to the foremost end of the rigid tube 116a. The rearmost end of the rigid tube 116a is in turn attached to the drive gear casing 114. Drive gear casing 114 is connected to an intermediate axle differential gear casing 112. Differential gear casing 112 is attached to a second section of rigid tube 116b which in turn connects to the rearmost axle differential gear casing 111. The tubular transmission member is made up of the casings 111,112,113,114 and the rigid tubing 116a,b. Rigid tubes 116a,b are generally cylindrical and thereby define the transmission axis 1010 of the tubular transmission member 110.

Seats 400, for accommodating a person, are shown to give an indication of the scale of the described embodiment.

Referring primarily to FIG. 3 and FIG. 4, ladder structure 120 comprises a first structural member 122 and a second structural member 124. These members 122 and 124 run generally parallel to one another and the longitudinal axis. Each member axis is displaced from the TTM axis 1010 by the same distance. The first structural member 122 and the second structural member 124 are both connected at an uppermost surface of their foremost ends to rigid plate 130. Hence the foremost end of the structural members are fixedly located. Other sections of the structural members are connected to one another by means of an ‘S’-sectioned brace 121, webbed brace members 123 and 125, and brace 127.

Ladder structure 120 is connected to tubular transmission member 110 by joists 126, 128, 129 and 131. Each joist has a central section to which transmission casings can be bolted and also arm sections, one of which extends to attach to structural member 122 and the other of which extends to attach to structural member 124. The joists fix the transmission member below the ladder structure.

Each structural member 124, 122 has a C-shaped cross section (i.e. the section forms three walls sections, the first and second of which are generally parallel, the third being perpendicular to the two and extending between the extremity of the first to the extremity of the second; there is a fillet at the join between wall sections). The structural members 122, 124 are arranged relative to each other so that the open aspect of the C-shaped cross section face away from each other. Having the members 112 and 124 arranged like this allows further components of the vehicle, such as the air suspension units, to fit neatly into the ladder member 120 (on platforms such as 181) thus saving space.

Referring primarily to FIG. 5, the arrangement of the foremost section of the chassis is explained. Hammer head plate 140 comprises a neck section 141, attaching at a first end to the foremost end of casing 113, and a wedge section 142 extending forward from the second end of the neck section 141 and flaring out to form a head member 147 with an axis normal to the tubular transmission member axis. This head member 147 has sides 145 and 144. Wedge section 142 comprises a first prominent undercarriage surface 143. The surface 143 is attitudinally inclined to the TTM axis 1010 by angle α, that is to say it extends from a minimum clearance at its rearmost end to a maximum clearance at its foremost end. The hammer head 140, and in particular the first prominent undercarriage surface 143, is at a foremost extremity of the vehicle and this results in the surface 143 being struck when driving over obstacles having a height approximately equal to the clearance of the hammer head plate 140.

Sides 145 and 144 of hammer head plate 140 are attached by means of interfaces 146 to the structural members 122 and 124 respectively.

Plate member 130 has a generally flat section which attaches to the uppermost side of structural members 122 and 124. However, plate member 130 also has a trough section 132 which, following the plate member 130 forwards from the foremost end of the flat section, dips downwards to form a surface covering the foremost end of the structural members 122, 124. The structural members 122 and 124 meet the trough section 132. The lowest point of this trough 132 effectively forms a member 133 along an axis normal to the tubular transmission member axis. The member 133 is located in a space aligned between the structural member axes and the tubular transmission member axis 1010. Member 133 has a second prominent undercarriage surface 135 which is attitudinally inclined to the transmission member axis 1010.

Such an arrangement results in member 133, and in particular second prominent undercarriage surface 135, being the most prominent member of the undercarriage as the vehicle approaches obstacles with a height approximately equal to the clearance of the member 133.

Referring also to FIG. 2, forward of the trough section 132 is bumper 150 (not shown in FIG. 5). The bumper 150 extends forwardly from the trough section 132 and is attached to the mounts 152 and 151 which also extend out of the trough section 132. The foremost aspect of the bumper 150 is contained within a third prominent undercarriage surface 155. Surface 155 is attitudinally inclined to the tubular transmission member axis.

Referring additionally to FIG. 9, plate member 130 also comprises a rigid hood 134 which is attached to trough section 132. The hood 134 comprises two generally vertical panels 801, 802 that are generally parallel with the TTM axis (the panels laterally diverge towards the foremost end). As can be seen from FIG. 8, one vertical panel 802 tends towards alignment with structural member 122 and the other 801 tends towards alignment with structural member 124. Both extend upwardly from trough section 132. The top of the vertical panels 801, 802 are joined by a third panel. Referring to FIGS. 6 and 7, when the vehicle drives onto a rigid immoveable obstacle 200 having height h less than the maximum clearance (h₁) of the third prominent undercarriage surface 155 but greater than the minimum (h₂) clearance of the first prominent undercarriage surface 143, the object will hit the undercarriage at an attitudinally inclined surface. The reaction to this impact in addition to the combination of the vehicle momentum and the drive from the rearmost wheels will deflect the vehicle by forcing the undercarriage to slide up the obstacle, allowing the vehicle to progress in spite of the obstacle. Thus the obstacle will thus fail to represent an obstruction.

If the obstacle has a height h less than h₂ then it will simply pass beneath the undercarriage.

The arrangement of the foremost undercarriage is such that the vehicle is able to climb up a 40° ramp 300 without losing traction on the front wheels.

FIG. 8 clearly shows the foremost protrusions (155, 135 and 143) of the undercarriage and their position in relation to the tubular transmission member 110 and the structural members 122 and 124. The foremost protrusions are aligned directly in front of at least one of the axes of members 122,124 and 110. This makes the protrusions well suited for longitudinal impact as might arise if the undercarriage hits an obstacle of height h where h₁<h<h₂. This is because there is a minimal moment arm and so bending stresses are minimised.

The structural members 122 and 124 are made from high strength steel to maintain the chassis rigidity established by the TTM.

The Plate member 130 is made from high strength steel sheeting having a depth of approximately 6 mm. The structural members 122, 124 are fixedly attached to the plate member 150 by way of a puddle welding process.

Other aspects of the described HMV can be fabricated from materials and components known to the skilled man.

A wide range of variants of the described invention would be apparent to the skilled man as being within the scope of the invention.

The HMV may, for example, be a four wheel drive vehicle (i.e. two axle drive), particularly if the vehicle is not required to carry such a great load as the six wheel drive vehicle.

1. A chassis for a high mobility vehicle, the chassis comprising:
a tubular transmission member extending from a foremost axle to a rearmost axle, thereby defining a transmission axis;
a first structural member arranged generally parallel to the transmission axis, and attached to the transmission member; and
a deflection structure arranged such that, if the vehicle, in use, encounters an obstacle having a height greater than the clearance of the deflection structure above the ground, the deflection structure is operable in combination with the first structural member and the transmission member to cause the vehicle to overcome the object.

2. A chassis as claimed in claim 1, further comprising a second structural member arranged generally parallel to the transmission axis, and attached to the transmission member; and wherein the deflection structure is operable in combination with the first and second structural members, and the transmission member, to cause the vehicle to overcome the object.

3. A chassis as claimed in claim 2 wherein the first and second structural members define a plane, which, when the vehicle is travelling over the ground, is above the transmission member

4. A chassis according to claim 1 wherein each of the first and second structural members have a C-shaped cross section and the first and second structural members are arranged in relation to each other such that the open part of the members face away from each other.

5. A chassis as claimed in claim 1 wherein the deflection structure comprises a plurality of prominent undercarriage surfaces inclined to the tubular transmission member.

6. A chassis according to claim 5 wherein the deflection structure comprises a hammer head section comprising a neck and a wedge, the neck attaching to the foremost end of the tubular transmission member, the wedge providing a first prominent undercarriage surface.

7. A chassis according to claim 6, wherein the hammer head is attached to the first structural member at a first side of the wedge and is attached to the second structural member at a second side of the wedge.

8. A chassis according claim 7 further comprising a plate member to which the foremost portions of the structural members are attached.

9. A chassis according to claim 8 wherein the plate member comprises a trough section which is aligned in a space between the structural members and the tubular transmission member axis, wherein a second prominent undercarriage surface is provided by an outer surface of the trough section.

10. A chassis according claim 5 wherein the deflection structure comprises a bumper, the bumper providing a third prominent undercarriage surface attitudinally inclined to the transmission member axis.
